(19) United States
(12) Patent Application Publication
(10) Pub. No.: US 2002/0165945 A1
(43) Pub. Date: Nov. 7, 2002

(54) Method and system for registry flying in a network

(76) Inventors: Randy Buswell, Fremont, CA (US); Bach Le, San Jose, CA (US); Sui M. Lam, Fremont, CA (US); David Stone, Fremont, CA (US)

Correspondence Address: Timothy H. Gens, The Technology Law Group, 265 Cambridge Avenue, Box 61029, Palo Alto, CA, 94306, US

(21) Appl. No.: 09/850,184

(22) Filed: May 7, 2001

(51) Int. Cl. G06F 15/167

(52) U.S. Cl. 709/221; 709/216

(57) ABSTRACT

A method and system for updating or making configuration changes to terminals by registry flying in a network is disclosed. The present invention is particularly useful to update or make configuration changes to an individual terminal in a thin client network. A registry is configured at a particular master terminal and the changed registry is transferred or flown via several different types of mechanisms to a management application using a management tool. The management application replicates and pushes the registry to one or more terminals or clients within the thin client network either successively or simultaneously. Several transport mechanisms can also be utilized to fly the registry to one particular terminal or a plurality of terminals.

### BACKGROUND OF THE INVENTION

1. Technical Field:

The present invention is directed to a method and system for managing configuration information using registry flying in a network. Still, more particularly, the present invention relates to an improved method and system to change a configuration at one or more terminals by changing and utilizing a terminal's registry within a thin client network.

2. Description of the Related Art:

Mainframe-based computing, with access via traditional terminals, has advantages that continue to make it a viable environment for many companies. Traditional terminals are a simple, low-cost solution that provides security, fast data entry, and a long, reliable life with their applications centrally managed. But these terminals have disadvantages in that they are inflexible, lack the graphical user interface (GUI) of modem applications, are typically monochrome, depend on a host, and have gained an image as an outmoded way of computing.

The desktop PC-based environment has advantages that have led to explosive growth in enterprises of all sizes. Compared to traditional terminals, PCs give their users more computing power and more control over applications and data, and can be upgraded to keep up with leading-edge hardware and software. The Windows operating system features an easy-to-use GUI and thousands of compatible applications. But PCs, too, have disadvantages. They are costly, difficult to manage, provide little security, and grow obsolete quickly.

The gap between these environments is extreme. But information technology (IT) managers must deal with them both—and manage the problems and complications that arise when PCs in client/server environments try to emulate the functionality of terminals and mainframes. The difficulties of managing complex PC-based networks, the emergence of the Internet/intranet, and the creation of the Java development language have recently spurred the creation of new server-centric solutions that fill the gap between mainframes/terminals and PCs.

These new combinations of hardware and software solutions are known collectively as thin-client computing. Thin-client products are devices that do not include hard drives and other components found in PCs. The complete or “fat” applications remain on the enterprise's server, while a small amount of “thin” code runs on the user's desktop system and provides access to the server. With most functions residing on the server, thin clients are more manageable and offer better solutions for security, safety from viruses, ease of software upgrades, and a host of other information technology concerns.

Unfortunately, new problems are created for thin clients when they are included in networks comprising many servers and a plurality of thin clients. A need exists for upgrading and configuring the terminals to run specific applications residing on the many servers. A further complication is to provide administrative access from a central site to an individual terminal or group of terminals on the thin client network. Therefore, a need exists for dynamically configuring and/or upgrading terminals either individually or by mass deployment to all terminals in a thin client network. The subject invention herein, solves this problem in a unique and novel manner not previously known in the art.

### SUMMARY OF THE INVENTION

The present invention utilizes various mechanisms to allow a user to configure a master terminal in a network. That configuration is then replicated and deployed, in whole or in part, using a transport mechanism over a network to one or more clients by a single administrator from a central site.

The present invention discloses a computer utility and method for managing configuration information by registry flying in a thin client network. A plurality of thin client devices connects via a plurality of communications links to the thin client network. Each thin client device is capable of receiving and serving requests connected via one of the communications links to the thin client network. Each thin client device has a current registry containing configuration information. Any thin client on the network can be configured to be a master thin client whose registry contains configuration information that is common to all thin clients on the network or a specific group. Any one of the thin client devices is capable of serving a request to either a software repository or another thin client device to pull the master thin client device registry stored on either the software repository or the master thin client device. Either the software repository or the master thin client device is capable of replicating the master thin client registry and transporting the master thin client registry via a transport mechanism to one or more of the plurality of thin client devices.

The present invention also provides a thin client network and method for managing configuration information by registry flying with a plurality of thin client devices connected via a plurality of communications links to the thin client network. Each thin client device is capable of receiving and serving requests connected via one of the communications links to the thin client network. Each thin client device has a current registry containing configuration information. A master thin client device registry contains configuration information changed from the current registry of any one of the plurality of thin client devices. A software repository resides on a network server and stores the master thin client device registry so that the master thin client registry can subsequently be pulled by a second one of the plurality of thin client devices so that second thin client device takes on the configuration of the first thin client device.

The present invention further discloses a computer utility for finding a device on a thin client network which includes a plurality of thin client devices connected via a plurality of communications links to the thin client network. Each thin client device is capable of receiving and serving requests connected via one of the communications links to the thin client network. Each thin client device has a current registry containing configuration information. Any one of the thin client devices is capable of receiving a request for identification to the thin client network. Either a SNMP query is made of every address in a network checking to see if it is a thin client terminal or a unique packet is broadcasted on each of the selected subnets. When the thin client terminal receives the unique packet it responds with a response packet back to the server requesting the discovery.

The present invention also includes a software key that is a part of a binary's bundled file. When a binary is downloaded to a terminal, the terminal will check the software key embedded in the binary and do a comparison of the information contained therein. The terminal will then be able to determine if the binary image or registry settings bundle can be accepted and start to make changes to the configuration of the terminal. If it is determined from the software key that the download is not authorized, the configuration of the terminal will not be changed.

An object of the present invention is to provide upgrades and make configuration changes from a master terminal to one or more clients or terminals over a network even in a thin client environment.

Another object of the present invention is to provide a method and system for making configuration changes in a registry, in whole or in part, or creating a new version of a binary and distributing the changes through a network to individual terminals.

A further object of the present invention is to provide mass deployment upgrades and configuration changes from a master terminal to a plurality of terminals in a thin client environment that prevents accidental changes to the registry or binary during replication and deployment.

An additional object of the present invention is to allow a single administrator to manage a plurality of thin client devices from a central remote site.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates current management strategy for a thin client network for data processing systems;

FIG. 2 is a diagram showing one embodiment of a management tool for updating or making configuration changes to terminals in a thin client environment in accordance with the present invention;

FIG. 3 is a diagram showing another embodiment of a management tool for updating or making configuration changes to terminals in a thin client environment in accordance with the present invention; and

FIG. 4 is a diagram illustrating several preferred embodiments of the present invention for transporting or flying a registry from a particular terminal to additional terminals in a thin client network.

### DETAILED DESCRIPTION OF THE PREFERRED EMBODIMENT

Configuration And Transport

Generally, the present invention utilizes various means to allow a user to configure a master terminal in a network. That configuration is then replicated and deployed, in whole or in part, using a transport mechanism over a network to one or more clients. Examples of configuration methods include, but are not limited to, web based management tools, Virtual Network Computing (VNC) server/client, a Simple Network Management Protocol (SNMP) agent/tool, Dynamic Host Configuration Protocol (DHCP), and a HyperText Markup Language (HTML) server/client. The transport mechanism can be any suitable protocol. For example and not limitation, SNMP or a private tool can be used to invoke the underlying transport mechanism such as File Transport Protocol (FTP) and/or Trivial File Transport Protocol (TFTP) which are Internet protocols (and program) used to transfer files between hosts. As used herein, the term configuration refers to the information that controls how the device works. The term binary means a combination of machine executables combined into a bundled image which is downloaded to a terminal and then broken apart by the terminal firmware into individual executables which are loaded into the appropriate places in the terminal. The term registry refers to configuration information that is stored on the terminal that controls various aspects of the software and applications. The term software repository refers to a storage space on a server that contains terminal registries or binaries that can be accessed by a thin client though FTP, TFTP, Microsoft SMB, or some other file transport protocol.

The software supports FTP, which is used exclusively for firmware images upgrades and remote terminal configurations. Use of TFTP or MICROSOFT SMB is also suitable. The present invention uses DHCP and FTP to provide automated downloading of a new image or registry via the network. For this process to work, the inventive software uses DHCP to get an IP address and DHCP tags instead of using a static IP address. Information on where to look for a new registry, configuration or binary can be retrieved from the DHCP tags.

The update process functions such that on boot, the software downloads new custom DHCP Tags indicating the following: a) the FTP server on which the software image and control files are found; b) the FTP server's root directory path on the server where software image and control file are found; c) a list of IP numbers for SNMP trap destinations; d) the SNMP Set Community.

After a DHCP Tag has been received, the inventive software uses information in the local copy of the control files to determine the path from the FTP base directory where the terminal specific files on the host or FTP server (including control, base image files and option image files) are retained.

After the correct path has been determined, the terminal will connect via FTP to the specified \\server\path and download all control files. The software will then compare the build number information and modification data information of the FTP server files with the local files to determine if an upgrade is required. If all strings match with the upgrade information, the terminal will complete the boot into the user interface and function normally. If any string does not match, the inventive software will continue the upgrade process by downloading the appropriate bundled base, option, or add-on binary image indicated by the server into RAM. If the terminal does not have sufficient RAM to hold the image, the inventive software will unbundled the image on the fly. During the network transfer of an image, if the network download is interrupted due to a loss of the network connection or power to the unit, the inventive software will not be adversely affected. After the entire image is downloaded to RAM, the software will unbundle the image and update the Boot Block and NAND Flash, where the main executables are kept. The boot block is checked first, and if the boot block code has changed a new boot block will be downloaded. Next, the NAND Flash is written. In the case of two or more NAND Flashes, the upgrade will write first to the main Flash, then the second and follow-on flashes. The upgrade process will determine what the best fit of the executables is for each Flash. This updating of Flash is similar to the update performed when downloading an image to the inventive software through a Parallel, Serial, or Flash Card update. If power is interrupted during the file transfer to the boot block (this period is extremely small since the component is only 256K bytes in size), the boot block may be corrupted requiring a new pre-programmed component to be installed. If the connection to the network or power is interrupted during a file transfer to the NAND Flash (this time period too is small and takes only a few seconds to complete the upgrade), the NAND Flash main image code may be corrupted requiring a serial, parallel, or flash card update. Once the image update has been completed, the software will automatically reboot.

In the software, SNMP enhancements and a portion of the Management Information Base (MIB) can be used to determine and/or configure hardware and software configurations such as network connections, user definitions and SNMP trap destinations, ROM configuration, PCMCIA devices, IO devices, display characteristics, DHCP information received from the DHCP server for the custom option values, ROM image information associated with the ROM images actually loaded on the Winterm and those for the images loaded on the FTP server, and custom field content. An upload or download process can be initiated by setting proper values through fields within the SNMP MIB. As the terminal comes up, SNMP traps are sent to the network to notify a management program that the terminal is active or coming up. The management programs can use the traps to determine the current version of the terminal and initiate uploads or downloads as required.

Support is added through SNMP and FTP to cause an interactive or automated downloading of a new image via the network. For automated downloading, through a management program, such as Tivoli, the administration program is able to detect the appropriate SNMP traps and through scripting identify the current revision of software and initiate file uploads or downloads to the inventive software. Through SNMP, the current software revision can be obtained by requesting software revision information. SNMP scripting can then determine whether the terminal has the appropriate software by comparing server based and terminal based software revision information. The script can then have the terminal initiate a bundled image update. Bundled image updates are handled identically as in DHCP image updates with the exceptions that: the FPT/TFTP server, path and filenames to be downloaded are specified via setting appropriate objects in the SNMP MIB. Any downloads requested through the SNMP interface will be attempted unconditionally. Once the image update has been completed, the software will automatically reboot. SNMP can also be used to upload configuration information by telling the terminal to put configuration information onto the server.

The present invention uses SNMP to remotely configure the terminal on a thin-client network. Typical configuration settings that can be remotely administered include, but are not limited to, the network interface, display, keyboard, any peripheral, any terminal emulation characteristics, security features, user account information, etc. This configuration data differs from information data which includes information about the RAM and FLASH memory, other hardware information, PC card slots, what PC card is plugged in, what peripherals are attached, the maximum resolution supported for display, what frequency is supported for the display, what information DHCP obtained, etc.

The present invention can also utilize the enhanced remote administration functions using industry standard protocols described in copending application entitled “Improved Method And Apparatus For Display Of Windowing Application Programs On A Terminal” filed as Wyse-004 and incorporated in its entirety herein by reference. These enhanced remote administration functions perform software image upgrades, modify terminal user-interface selections, and improve terminal status reporting.

Current Management Strategies For Thin Client Networks

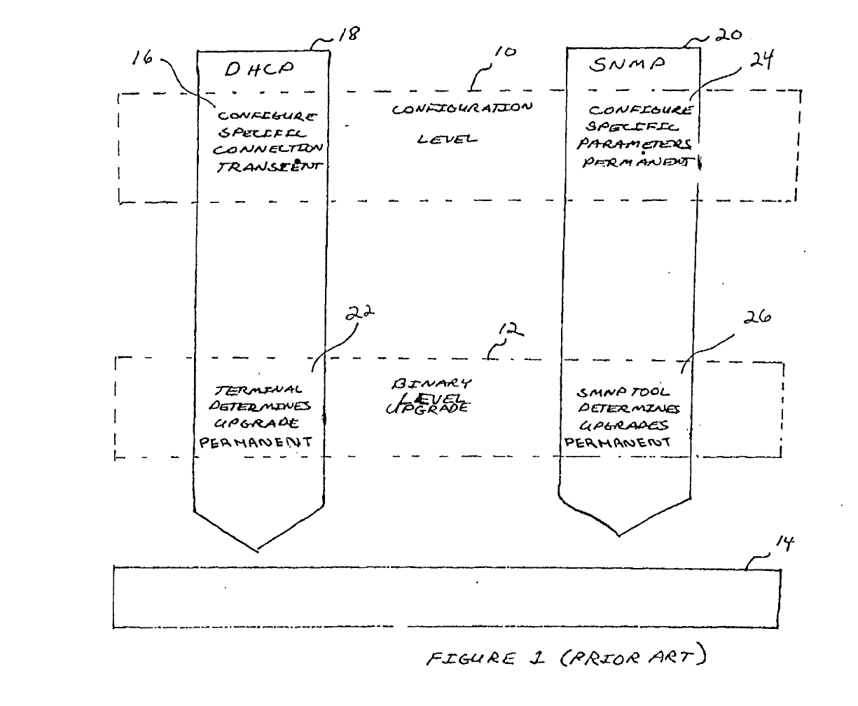

FIG. 1 illustrates one of the current management strategies for thin client networks. There are two functional layers, Configuration Level 10 and Binary Level 12, which lead to a physical layer 14 providing the management of a thin client terminal. At Configuration Level 10, a device such as a thin client terminal can be configured either permanently or provide a transient configuration such as through a power on boot of the device.

The Binary Level 12 provides permanent upgrades through either DHCP 18 or SNMP 20. Using DHCP 18, a decision point 16 is reached at configuration level 10 to configure a specific connection or support a registry transfer. In practice, a user simply turns on the power to a thin client terminal. As it boots, the terminal determines from DCHP tags that a connection can be created or it will automatically pull a registry. Without further user input, a connection is created to establish a configuration that is transient and, therefore, is lost when power to the terminal is turned off. At the Binary Level 12 using DHCP 18, another decision point 22 is executed wherein the terminal determines whether to upgrade at power-up. Once the terminal is upgraded at time of power-up, the upgrade is permanent until a newer upgrade is available.

Using FIG. 1, SNMP 20 can be used to individually configure the device. At decision point 24, configuration level 10, a SNMP management tool can be used to configure specific parameters permanently through SNMP. The decision point 26 at the Binary Level 12, determines whether the terminal should be upgraded. Any upgrade to the terminal through SNMP is permanent in nature.

Registry Flying

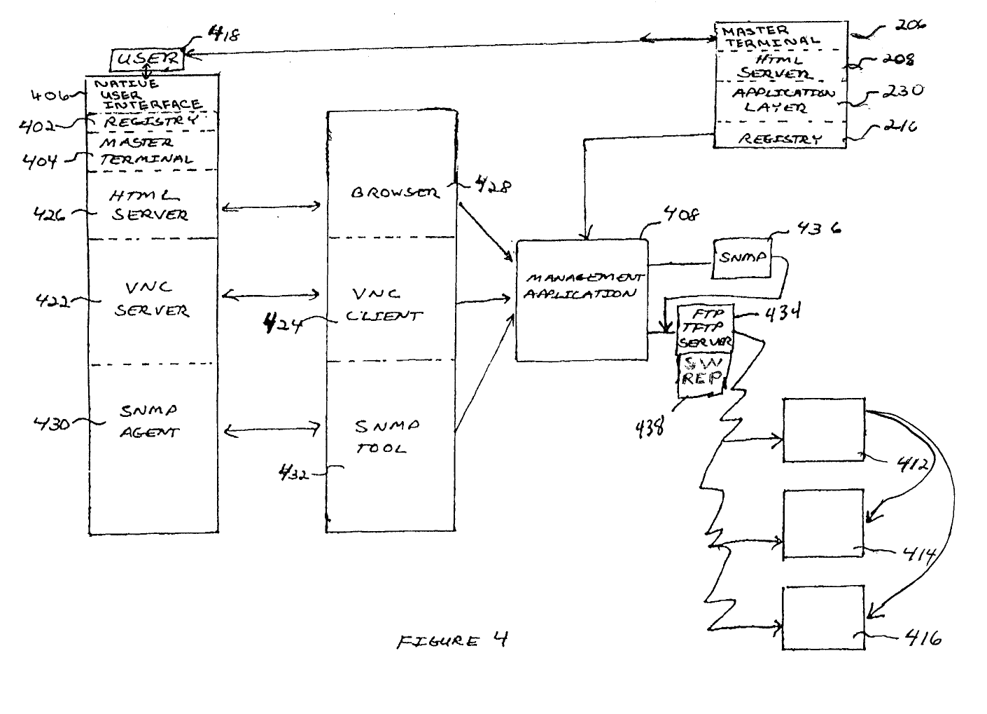

In accordance with the general embodiment of the present invention illustrated in FIG. 4, a thin client network uses the inventive registry flying method to configure a registry 402 at a particular master terminal 404 and transfer or fly that registry 402 via several different types of mechanisms to a management application 408. The management application 408 replicates and pushes the registry 402 to one or more terminals or clients such as 412, 414, and 416 within the thin client network either successively or simultaneously.

Creating or Modifying a Configuration

A system administrator or user 418 can configure master terminal 404 by changing the registry 402 into any type of configuration through a native user interface. Instead of having a user affect the registry 402 through the native user interface 406 of the master terminal 404, other mechanisms can be used to configure the registry 402 on the master terminal 404. For example and not limitation, a Virtual Network Computing (VNC) server/client, a HTML server/client, and a SNMP agent/tool are suitable configuration methods, provided the appropriate mechanisms are available on the master terminal 404.

In a second mechanism for configuring the registry 402, a VNC client 424 communicates to a VNC server 422 to make changes thereon. The master terminal 404 can provide the VNC server 422 integrated therewith and the VNC client 424 can be an integral part of the management tool 408. It is also suitable for the VNC client 424 to be connected to, but otherwise separate, from the management application 408 such as residing on another device or independently on a dedicated device. The VNC server 422 can allow shadowing. The VNC client 424 provides a remote interface like the master terminal 406 user interface. The VNC client 424 can communicate to the VNC server 422 to make a change to the master terminal 404 through shadowing of the terminal interface. This method is similar to a user sitting at the master terminal 404 and making changes with the native terminal user interface 406. Typically, only one device at a time can be configured through VNC.

A third mechanism can be used to configure the registry 402 on the master terminal 404 and initiate the registry flying method of configuring additional terminals. The master terminal 404 provides an SNMP agent 430 that is connected to an SNMP tool 432. The management application 408 through scripting or direct reference can use SNMP tool 432 to modify the configuration of the registry 402. Changes to the registry 402 are restricted to those fields available in the SNMP MIB, unless a global modification field is available in the MIB that allows direct manipulation of the registry . The SNMP Tool 432 can be an integral part of the management application 408. It is also suitable for the SNMP Tool 432 to be connected to, but otherwise separate, from the management application 408 such as residing on another device or independently on a dedicated device. Changes made to the registry 402 are permanent and care should be taken that the wrong registry field is not changed through the SNMP agent 430. Use of SNMP and scripting allows multiple thin client devices to be configured with the same configuration from one remote management tool at the same time.

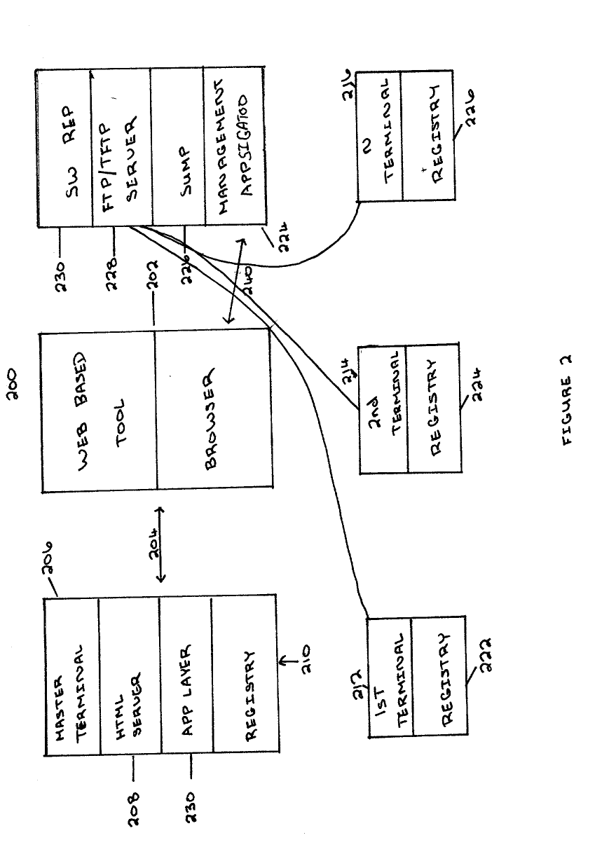

Referring to FIG. 2, a fourth mechanism can be used to configure the registry 210 on the master terminal 206 and initiate the registry flying method of configuring additional terminals. The master terminal 206 provides a HyperText Markup language (HTML) server 208 incorporating web pages. The user by modifying the configuration fields of the web page with a web based tool 202, such as Microsoft Internet Explorer, inherently affects the configuration parameters of the registry 210 through the application level 230. Application level 230 is able to recognize user configuration changes from the HTML server 208 and translate the changes into relevant modifications to the registry 208 on the master terminal 206. The changes made to the registry 210 are permanent. Typically, only one device at a time can be configured through HTML.

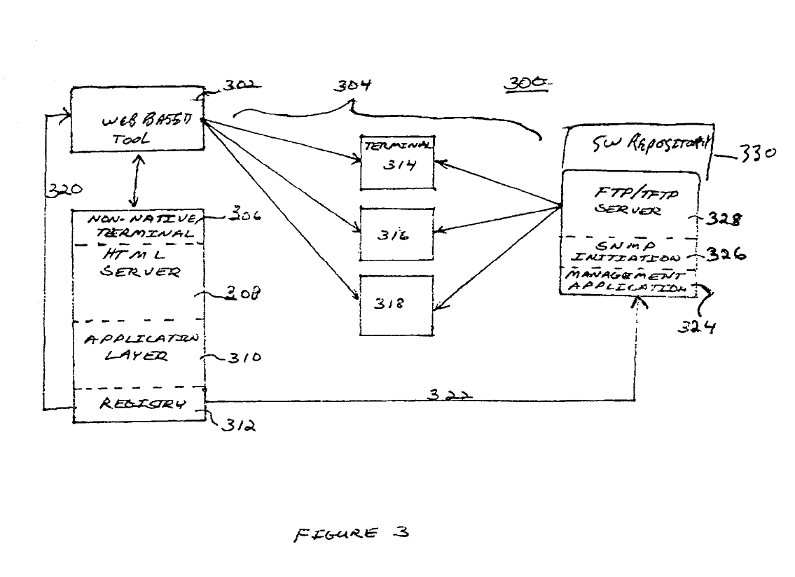

A fifth mechanism is described with reference to FIG. 3, a non-native terminal 306 like a personal computer (PC) or other device not native to a thin client network 304 is used instead of a master terminal in FIG. 4 to create the registry. A web based tool, such as a browser, 302 connects across the thin client network 304 to communicate with the non-native terminal 306 providing an HTML server 308 incorporating one or more web pages therein. The HTML server 308 is in communication with a registry 312 through an application layer 310 that is used to create or configure the registry 312. Once the registry 312 has been configured, it can be transported to the software repository 330 though Microsoft SMB or similar transport.

The difference between configuration methods 300 and 400 in FIGS. 3 and 4, respectively, is where the registry is created. There is a different level of functionality required to create the registry between the master terminal 404 or other native device on a thin client network and a PC or other non-native device 306. The functionality of the native master terminal 404 can be used to directly create the registry locally on the device. To create a registry on a PC, a application program 310 must be coded that simulates a native device. Creating a registry requires considerable more time and effort with a PC compared to a master terminal.

Optionally, the management application 408 can receive the registry 402 from the master terminal 404 and merge the registry 402 with a new binary to create another binary image that is stored in a software repository 438. The combined image may contain updates or changes to enhance or fix functionality.

To transport or fly the updated registry 210 or 402 from the master terminal to additional terminals, the management application 408 preferably using SNMP 436 and FTP/TFTP server 434, first transfers or flies the registry to a software repository 438. Other transport mechanism such as Microsoft SMB or TFTP may also be used. Once the registry has been stored into the software repository, it can either be combined with a new binary or sent directly to other terminals within the thin client network.

Updating a Device

The present invention provides several mechanisms to transport or fly the registry to additional terminals. As described herein and as example, the management application 408 controls replication of the registry 402 to software repository 438 through SNMP tool 432. Once the registry is stored in software repository 438, the management application 408 can communicate with one or more terminals such as 412, 414 and 416 within the thin client network either successively or simultaneously to initiate through SNMP a transfer of the registry from the software repository 438 to the terminal. SNMP 436 initiates the transfer of the registry 402 or binary image from the software repository 438 on FTP/TFTP server 434 to the terminal 412. Each one of the download operations from the management application 408 to the individual terminals can be a time consuming process that drains network resources. After a new registry or binary is downloaded to the terminal, a Reboot must occur for the change to take effect.

In a second update mechanism, either the registry 402 or a new version of a binary is downloaded only to a first terminal 412 as in the first mechanism previously described. Instead of downloading the registry 402 or the new binary version from the management application 408 to the additional terminals 414 and 416, the registry 402 or new binary version on the terminal 412 is replicated and transported to the other terminals 414 and 416. The transfer can be implemented through the FTP or TFTP mechanisms. This “buddy” method is particularly advantageous in utilizing network resources because terminal 412 is local to terminals 414 and 416 and is usually on a faster network. Thus, it will not take as long to replicate or propagate the registry 402, or optionally, the new version of the binary, to other local terminals. After a new registry or binary is downloaded to the terminal, a REBOOT must occur for the change to take effect.

Certain fields should be masked out when the registry 402 is transported or flown to additional terminals to prevent replication of IP numbers or other parameters that should remain unique for the network to communicate with an individual terminal.

An example of implementing the inventive registry flying is the Wyse 3000 Administration Tool that uses a basic embodiment of registry flying as the mechanism for performing the basic registry and binary updates on a thin client network. The user takes the registry on the master terminal. The registry is flown to the application that sends the information to each individual device. The management of the device is through SNMP and transport within the network is with FTP.

Transport Mechanism Examples For Use With Registry Flying

In general the management application 408 requests the terminal to perform the required action of uploading or downloading a registry or binary image. The terminal then requests through FTP or some other convenient transport mechanism the required information. This is known as a “pull” type of update. Since the terminal controls the transferring, “pull”, of the information, it knows when an error occurs or the transfer is complete and can communicate this back to the management application 408.

To upload a master terminal registry configuration 402, the terminal is requested to upload the registry 402 by the management application 408 to a specified software repository 438 on FTP server 434. The request to upload the registry 402 to the server is performed by the management application 408 through the SNMP tool 432. The SNMP request to upload the registry may include the destination FTP server name and directory path or the terminal may determine the FTP destination itself through pre-configuration and defaults. Additionally, the management application 408 must provide username and password information to the software repository 438.

To download a terminal registry 402 or binary image to thin client 412, 414, and 416, the management application 408 sends a request through SNMP 436 to each terminal individually. The SNMP request to download the registry or binary image may include the source FTP server name and directory path or the terminal may determine the FTP source itself through pre-configuration and defaults. Additionally, the management application 408 must provide username and password information to the software repository 438. A reboot is required after the transfer has been completed.

Once the registry has been transferred to thin client 412, 414, or 416, the thin client must resolve the differences between the new registry and it's current registry by determining the differences, updating itself, then rebooting for the differences to take effect.

Other transfer mechanisms such as TFTP or Microsoft SMB may also be used to transfer configuration of binary information to the different terminals within the thin client network.

Management Tool Examples For Use With Registry Flying

There are several management tools that can use the inventive registry flying to manage an individual terminal or a plurality of terminals in a thin client network. As illustrated in FIG. 4, management tool 408, a WIN32 application, uses network services SNMP 436, FTP/TFTP server 436, and software repository 438 to manage the thin client network. The management tool 408 and network services SNMP 436 and software repository 438 on FTP/TFTP server 436 can be distributed across the network or reside on a single management server.

The management tool 408 provides a simple user interface to the thin client administrator that allows him or her to view all thin clients within the network and manage these devices on a global or individual basis. The tool provides the basic ability to group devices, script actions such as updates or maintenance, and schedule when the actions will occur. Additionally, the management application 408 provides the ability to interface to the master terminal 404 to create or modify the registry 402. Once the registry 402 has been modified, the management tool 408 can move or fly the modified registry from the master terminal 404, through the software repository 438, and to a client 412 on the network.

Grouping of terminals, for example 412, 414, and 416, or other terminals on the network, allows the management application to perform the same task on related terminals through one action. Grouping can be, for example by location, by IP range, or by department. The group can then be scheduled for periodic maintenance at various dates or times.

Certain fields should be masked out when the registry 402 is transported or flown to additional terminals to prevent replication of IP numbers or other parameters that should remain unique for the network to communicate with an individual terminal. These fields are typically cleared or removed by the management application 408 after the registry has been deposited into the software repository 438 and prior to transferring the registry information 402 to other thin client devices. Once receiving terminals 412, 414, 416 receive registry 402, they must fill in the fields cleared by the management application 408 before saving the information to flash and rebooting.

Additionally, the management application 408 can combine the registry information 402 stored in software repository 438 with a binary image to create a new binary image that has the configuration of the master terminal 404. The new binary image is then stored in the software repository 438 for later transfer. Combining the registry and new image together prior to transferring to other thin client devices saves network bandwidth and assures that all devices will have the same configuration. The binary image that is combined with registry 402 must be of similar operating system as the original master terminal 404.

Management application 408 may have additional capabilities to initiate and coordinate Buddy updates or automatic configurations through SNMP 436.

In another embodiment of the management tool, as illustrated in FIG. 2, a browser 202, such as Microsoft Internet Explorer, is used to connect across the thin client network 240 to communicate with management application 224. Management application 224, like management application 408 in FIG. 4, has similar capabilities to update and configure clients on the thin client network. Management application 224 has the additional ability to be accessed by a browser 202 from anywhere that has network connectivity, thus affording the thin client administer the ability to administer the thin client network from home or on the road. Software repository 230 on FTP/TFTP server 228, and SNMP interface 226 may reside on one server or reside on different servers within the thin client network.

Preferably, terminal 206 is a Windows-based terminal, as manufactured and offered by Wyse Technology which provides access across any type of network to the full Windows NT® operating system environment, including virtually any Windows application. The Windows-based terminal 206 puts full Windows NT functionality on a workstation terminal and provides complete, enterprise-wide access to 16- and 32-bit Windows, Java, and legacy applications, and to the Internet/intranet, with a user-friendly graphical interface. Applications run on a server anywhere within the thin client network 204, not the terminal 206, allowing for centralized management, enhanced security, and exceptional, cost-effective performance. By way of example, but not of limitation, one type of multi-user Windows application server technology using Windows terminals is MetaFrame® software from Citrix Systems. For the user, the Windows-based terminal provides access to applications (including 32-bit Windows-based applications) across platforms, complete Web access and functionality, and high-performance access to business-critical applications over remote connections.

It should be understood that Windows-based terminals have the unique ability to separate an application's interface from its execution. During a computing session, only mouse clicks, keystrokes, and screen updates travel the thin client network. All processing occurs on a network server, so a Windows-based terminal requires only one-tenth the bandwidth of a conventional client/server network. Windows-based terminals come in several form factors: an integrated model with thin-client capabilities built into a monitor, a small box that plugs into a conventional monitor to provide thin-client computing, or a wireless thin-client device. Each terminal 206 normally contains a CPU for processing graphics, keyboard and mouse, an Ethernet network interface, a video subsystem and monitor, and locally stored software (on Flash ROM) to enable connection to the Windows NT application server environment (not shown). Though applications run on the network server, they look, feel, and respond just like applications running locally. Users perform all application functions just as they would on a conventional PC-based desktop system.

Finding Terminals With The Management Application

As part of the management application 324, various terminals in the network can be found by using a Discover method and/or Reboot to implement changes to a terminal. The Discover Method selects whether you go through every unit in the selected subnets using SNMP queries (slow) or using Broadcast (fast). The SNMP method literally goes through every address in a subnet and queries that address, checking to see if it is a thin client terminal. The Broadcast method broadcasts a unique packet on each of the selected subnets. When the Thin Client terminal receives the unique packet it responds with a response packet back to the server requesting the discovery. Broadcast packets are sent on port 2343. For broadcasts on the server's local subnet a local broadcast (i.e., 255.255.255.255) is sent; otherwise, a broadcast that is specific to the physical subnet is sent (e.g., 132.237.14.255).

Software Keys

The present invention also includes a software key that is a part of a binary's bundled file. When a binary is downloaded to a terminal, the terminal will check the software key embedded in the binary and do a comparison of the information contained therein. The terminal will then be able to determine if the binary image or registry settings bundle can be accepted and start to make changes to the configuration of the terminal. If it is determined from the software key that the download is not authorized, the configuration of the terminal will not be changed.

Use of the software key prevents cross-pollinating binaries across platforms. The software key can be downloaded to a terminal at the time of manufacture. The software key can be stored in a non-volatile device, such as an EPROM.

It is also important to note that although the present invention has been described in the context of fully providing functional configuration changes and updates in a thin client network, those skilled in the art will appreciate that the mechanisms of the present invention are capable of being distributed as a program product in a variety of forms to any type of information handling system, and that the present invention applies equally regardless of the particular type of signal bearing media utilized to actually carry out the distribution. Examples of signal bearing media include, without limitation, recordable type media such as floppy disk or CD ROMs and transmission type media such as analog, digital, and optical communications links.

While the invention has been particularly shown and described with reference to a preferred embodiment, it will be understood by those skilled in the art that various changes in form and detail may be made therein without departing from the spirit and scope of the invention.

What is claimed is:

1. A computer utility for managing configuration information by registry flying in a thin client network, comprising:
a plurality of thin client devices connected via a plurality of communications links to the thin client network, each thin client device capable of receiving and serving requests connected via one of the communications links to the thin client network, each thin client device having a current registry containing configuration information;
a master thin client device registry containing configuration information changed from the current registry of any one of the plurality of thin client devices;
any one of the thin client devices capable of serving a request to either a software repository or another thin client device to pull the master thin client device registry stored on either the software repository or the other thin client device;
either the software repository or the other thin client device capable of replicating the master thin client registry and transporting the master thin client registry via a transport mechanism to one or more of the plurality of thin client devices.

2. The system for managing configuration information according to claim 1, further comprising:
the transport mechanism selected from the group consisting File Transport Protocol, Trivial File Transport Protocol and other Internet protocols.

3. The system for managing configuration information according to claim 1, further comprising:
the transport mechanism is triggered by Simple Network Management Protocol.

4. The system for managing configuration information according to claim 1, further comprising:
the transport of the changed registry to one or more of the plurality of thin client devices is simultaneous to all selected thin client devices.

5. The system for managing configuration information according to claim 1, further comprising:
the configuration information in the master thin client device registry is an upgrade for a binary or a registry.

6. A thin client network system for managing configuration information by registry flying, the system comprising:
a plurality of thin client devices connected via a plurality of communications links to the thin client network, each thin client device capable of receiving and serving requests connected via one of the communications links to the thin client network, each thin client device having a current registry containing configuration information;
a master thin client device registry containing configuration information changed from the current registry of any one of the plurality of thin client devices;
a software repository residing on a network server and storing the master thin client device registry so that the master thin client registry can subsequently be moved to another thin client device;
any one of the thin client devices capable of serving a request to the software repository to pull the master thin client device registry stored on either the software repository or the other thin client device, either the software repository or the other thin client device capable of replicating the master thin client registry and transporting the master thin client registry via a transport mechanism to one or more of the plurality of thin client devices.

7. The system for managing configuration information according to claim 6, further comprising:
the master thin client device registry having a plurality of fields, each of the plurality of field capable of being individually addressed.

8. The system for managing configuration information according to claim 6, further comprising:
at least one of the plurality of thin client devices having a native user interface for creating the master thin client device registry.

9. The system for managing configuration information according to claim 6, further comprising:
a Virtual Network Computing client and server, the software repository or the thin client device storing the master thin client device registry being in communication with the Virtual Network Computing client which provides a remote interface for creating the master thin client device registry, the Virtual Network Computing client communicates with the Virtual Network Computing server to make changes to the master thin client device registry through shadowing of the interface of the thin client device.

10. The system for managing configuration information according to claim 6, further comprising:
the thin client device storing the master thin client device registry provides a HyperText Markup Language server that is used to create the master thin client device registry, the HyperText Markup Language server provides a web page that reflects the configuration parameters of the master thin client device registry, a Browser is used to make permanent changes to the configuration parameters of the master thin client device registry that is reflected on the web page.

11. The system for managing configuration information according to claim 6, further comprising:
the thin client device storing the master thin client device registry provides a Simple Network Management Protocol agent that is connected to a Simple Network Management Protocol tool, the Simple Network Management Protocol tool is connected to the thin client device.

12. The system for managing configuration information according to claim 6, further comprising:
the thin client device storing the master thin client device registry is a non-native device to the thin client network, a browser connects across the thin client network to communicate with the non-native device providing an HyperText Markup Language server having one or more web pages therein, the HyperText Markup Language server is in communication with the master thin client device registry through an application layer that is used to create the master thin client device registry.

13. The system for managing configuration information according to claim 6, further comprising:
the configuration information in the master thin client device registry is an upgrade for a binary or a registry.

14. A thin client network for managing configuration information by registry flying comprising:
a plurality of thin client devices connected via a plurality of communications links to the thin client network, each thin client device capable of receiving and serving requests connected via one of the communications links to the thin client network, each thin client device having a current registry containing configuration information;
a master thin client device registry containing configuration information changed from the current registry of any one of the plurality of thin client devices; and
a software repository residing on a network server and storing the master thin client device registry so that the master thin client registry can subsequently be pulled by a second one of the plurality of thin client devices so that second thin client device takes on the configuration of the master thin client device.

15. The thin client network of claim 14, wherein the second one of the thin client devices is capable of replicating the master thin client registry and transporting the master thin client registry via a transport mechanism to one or more of the plurality of thin client devices.

16. The thin client network of claim 14, wherein the master thin client registry is merged with the current registry of one or more of the thin client devices from a first one of the plurality of thin client devices to create a merged thin client device registry.

17. The thin client network of claim 14, wherein the transport mechanism is selected from the group consisting File Transport Protocol, Transfer File Transport Protocol and other Internet protocols.

18. The thin client network of claim 14, wherein the transport mechanism is triggered by Simple Network Management Protocol.

19. The thin client network of claim 14, wherein the transport of the changed registry to one or more of the plurality of terminals is simultaneous to all selected terminals.

20. A computer utility for finding a device on a thin client network, comprising:
a plurality of thin client devices connected via a plurality of communications links to the thin client network, each thin client device capable of receiving and serving requests connected via one of the communications links to the thin client network, each thin client device having a current registry containing configuration information; and
any one of the thin client devices capable of receiving a request for discovery to the thin client network.

21. The system for finding a device on a thin client network of claim 20, wherein the discovery is through a Simple Network Management Protocol query to each one of the pluralities of thin client devices, the query identifying a thin client device exists.

22. The system for finding a device on a thin client network of claim 20, wherein the discovery is through a plurality of packets broadcasted by a server to each one of the pluralities of thin client devices, each of the plurality of packets having a unique identification, each one of the pluralities of thin client devices generating a response packet transported back to the server.

23. The system for finding a device on a thin client network of claim 20, wherein the transport mechanism is triggered by Simple Network Management Protocol.

24. The system for finding a device on a thin client network of claim 20, wherein discovery of a device on the thin client network manages the transport of a master thin client device registry to one or more of the plurality of thin client devices selected by the discovery.

25. The system for finding a device on a thin client network of claim 20, wherein the configuration information in the master thin client device registry is an upgrade for a binary or a registry.
